(19) United States
(12) Patent Application Publication
(10) Pub. No.: US 2007/0217022 A1
(43) Pub. Date: Sep. 20, 2007

(54) Colour Correction in a Variable Focus Lens

(75) Inventors: Stein Kuiper, Vught (NL); Bernardus H.W. Hendriks, Eindhoven (NL); Coen T.H.F. Liedenbaum, Oss (NL); Arjen G. Van Der Sijde, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,467

(22) PCT Filed: Mar. 31, 2005
(86) PCT No.: PCT/IB05/51083

§ 371 Date: Sep. 29, 2006

(30) Foreign Application Priority Data
Apr. 2, 2004 (GB) 0407494.4

(51) Int. Cl. G02B 3/14

(52) U.S. Cl. 359/666

(57) ABSTRACT

A variable focus lens of the type including a first fluid (A) and a second fluid (B), the fluids being immiscible and having different indices of refraction wherein the lens function of the variable focus lens can be selectively controlled. The refractive indices of the two respective fluids (A) and (B) are different, and it is highly advantageous if the difference between these refractive indices is relatively high, in order to obtain a good zoom factor. Many oils with a high refractive index (approximately above 1.7) are not colourless, but instead tend to be yellow. However, this causes colour changes in the image of an object compared with the object itself. This problem is solved by correcting or compensating for the resultant change of colour of an image of an object, compared with the object itself, caused by the use of a non-colourless fluid as the first and/or second fluid in a variable focus lens of the above-mentioned type.

This invention relates to a variable focus lens comprising a first fluid and a second fluid, the fluids having different indices of refraction, wherein the lense function of said variable focus lens can be selectively controlled.

A fluid is a substance that alters its shape in response to any force, that tends to flow or to conform to the outline of its chamber, and that includes gases, liquids and mixtures of solids and liquids capable of flow. Furthermore, the lens function of a variable focus lens is its ability to focus (converge or diverge) one or more wavelengthes of light.

International Patent Application No. WO 03/069380 describes a variable focus lens of the type including a substantially cylindrical fluid chamber having a cylinder wall and an axis, the fluid chamber including a first fluid and an axially displaced second fluid, the fluids being non-miscible, in contact over a meniscus and having different indices of refraction. A fluid contact layer is arranged on the inside of the cylinder wall, and the lens further comprises a first electrode separated from the first fluid and second layer by the fluid contact layer, and a second electrode acting on the second fluid. The fluid contact layer has a wettability by the second fluid which varies under the application of a voltage between the first electrode and the second electrode, such that the shape of the meniscus varies in dependence on the voltage, and the wettability of the fluid contact layer by the second fluid is substantially equal on both sides of the intersection of the meniscus with the contact layer when no voltage is applied between the first and second electrodes.

The equal wettability of the fluid contact layer on both sides of the intersection allows a larger movement of the meniscus and, as a consequence, a greater change in curvature of the meniscus. It allows a concave meniscus to become convex, and vice versa.

In one exemplary embodiment described in the above-mentioned document, the first liquid comprises an electrically insulating liquid in the form of an “oil”, and the second fluid comprises an electrically conducting liquid, i.e. an electrolyte. As stated above, the refractive indices of the two respective fluids are different, and it is highly advantageous if the difference between these refractive indices is relatively high, in order to obtain a good zoom factor, bearing in mind that the non-conductive fluid (e.g. oil) tends to have a higher refractive index than the conductive fluid (i.e. the electrolyte). Many oils with a high refractive index (approximately above 1.7) are not colourless, but instead tend to be yellow (for example, in the case of selenium disulfide, the refractive index n=1.85, and its colour is yellow). However, this causes colour changes in the image of an object compared with the object itself, such that a limitation is placed on the oils having a high refractive index which can be used in a variable focus lens of the electrowetting type.

Several other types of variable focus lenses are known which are based on the use of at least two liquids for example, lenses that work on meniscus translation by electrowetting or conventional pumping, and those which are based on binary lenses that are filled with either water or oil/air.

We have now devised an arrangement which overcomes the problems outlined above, and it is an object of the present invention to provide a variable focus lens of the type having a first fluid and a second fluid in which a change in colour between an image of an object compared with the object itself, caused by the use of non-colourless fluids, is compensated for. It is also an object of the invention to provide a method of compensating for colour changes between an image of an object and the object itself, caused by the use of non-colourless fluids, in a variable focus lens of the type having a first fluid and a second fluid.

In accordance with the present invention, there is provided a variable focus lens comprising a first fluid and a second fluid, said fluids having different indices of refraction, wherein the lens function of said variable focus lens can be selectively controlled, at least one of said fluids being non-colourless, the lens further comprising means for correcting for a colour change which would otherwise occur in an image of an object compared with the object itself as a result of said non-colourless fluid.

Also in accordance with the present invention, there is provided an optical system including a variable focus lens comprising a first fluid and a second fluid, the fluids having different indices of refraction, wherein the lens function of the variable focus lens can be selectively controlled, at least one of said fluids being non-colourless so as to absorb at least a portion of a light beam passing therethrough and causing a colour change in an image of an object compared with the object itself, the optical system further comprising means for correcting for said colour change.

In an exemplary embodiment, wherein the optical system comprises an electronic image sensor, means may be provided for electronically adjusting the white balance of the image so as to counteract the effect on the colour thereof by the non-colourless fluid.

In another exemplary embodiment, a dye or similar pigmentation material may be added to the non-colourless fluid to counteract the effect thereof on the colour of the image. Alternatively, or in addition, an appropriate colour filter means may be placed in the lightpath to counteract the effect of the non-colourless fluid on the colour of the image. Electronic colour adjustment may also be appropriate in this case, due to the fact that as the shape of the meniscus changes, the thickness of the non-colourless fluid layer varies.

In yet another exemplary embodiment, a dye or similar pigmentation material may be dissolved in the fluid other than the non-colourless fluid, the dye or other pigmentation material having substantially the same level and type of colour absorption as the non-colourless fluid.

An optical system incorporating a variable focus lens according to the invention may be arranged and configured such that the stop thereof is relatively close to the position of the meniscus between the first and the second fluid. Furthermore, the wall of the container within which the first and second fluids are housed may be shaped such that the thickness of the non-colourless fluid layer is substantially the same, irrespective of the shape of the meniscus, such that a single colour correction degree and method can be used in respect of the entire sensor.

It will be appreciated that the present invention finds application in any image capture device including a variable focus lens of the electrowetting type, and is particularly suitable for use in image capture devices and camera modules provided in or on portable telecommunications appliances, such as mobile telephones and the like.

In one exemplary embodiment, the second fluid may be axially displaced from the first fluid, the fluids being in contact over a meniscus, the lens further comprising a first electrode and a second electrode, wherein the shape of the meniscus can be controlled in dependence on the application of a voltage between the first electrode and the said second electrode.

In this case, preferably, the variable focus lens comprises a substantially cylindrical fluid chamber, and a fluid contact layer is arranged on the inside of the cylinder wall. The first electrode is preferably separated from the first fluid and the second fluid by the fluid contact layer, and the second electrode is preferably arranged and configured to act on the second fluid. The fluid contact layer is beneficially arranged to have a wettability by the second fluid which varies under the application of a voltage between the first electrode and the second electrode, such that the shape of the meniscus varies in dependence on the said voltage. In a preferred embodiment, the wettability of the fluid contact layer by the second fluid is substantially equal on both sides of the intersection of the meniscus with the fluid contact layer when no voltage is applied between the first and second electrodes.

In another exemplary embodiment, the lens may comprise a chamber defined by at least one side wall having an optical axis extending longitudinally through the chamber, wherein the chamber contains the fluids, which are in contact over a meniscus, the lens further comprising at least one pump for altering the relative volume of each of the fluids contained within the chamber. In a first specific arrangement, the perimeter of the meniscus may be constrained by the side wall, and the at least one pump is arranged to controllably alter the position of the meniscus along the optical axis by altering the relative volume of each of the fluids contained within the chamber. In an alternative, specific arrangement the perimeter of the meniscus may be fixedly located on an internal surface of the chamber, and the at least one pump is arranged to controllably alter the shape of the meniscus by altering the relative volume of each of the fluids contained within the chamber.

In this case, the wettability of the internal surface of the chamber preferably varies longitudinally, and is most preferably arranged to be controllably altered by the electrowetting effect.

In yet another exemplary embodiment, the lens may be arranged to provide a variable zoom setting for a beam of radiation, and preferably comprises a switchable optical element having a first mode and a second mode, the element including the first fluid, the second fluid and a wavefront modifier having a part through which the radiation is arranged to pass, where in the first mode, the switchable optical element has a first fluid configuration in which the part is substantially covered by the first fluid, and in a second mode, the switchable optical element has a second different, fluid configuration in which the part is substantially covered by the second fluid.

In this case, the switchable optical element preferably comprises a common first fluid electrode, a second different fluid electrode and a third, different, fluid electrode, wherein in the first fluid configuration, the element is arranged to provide switchable electrowetting forces by applying a first voltage across said first and second fluid electrodes, and in the second fluid configuration, the element is arranged to provide different switchable electrowetting forces by applying a second, different voltage across the first and third fluid electrodes.

In all cases, the first and second fluids are beneficially immiscible, i.e they do not mix.

The first fluid preferably includes an insulating fluid and the second fluid preferably includes a conducting liquid. The insulating fluid preferably has a higher index of refraction than the conducting fluid, and beneficially includes or comprises the non-colourless fluid. The non-colourless fluid is beneficially a liquid having an index of refraction greater than 1.5 and, more electrowetting, greater than 1.7. The non-colourless fluid beneficially comprises an oil having a refractive index greater than 1.5 and, more electrowetting greater than 1.7. The non-colourless fluid is preferably yellow, brown or red, but most preferably yellow.

The present invention extends to an image capture device including a variable focus lens or optical system as defined above. The present invention also extends to an optical scanning device for scanning an optical record carrier, the optical scanning device including a variable focus lens or an optical system as defined above.

These and other aspects of the invention will be apparent from, and elucidated with reference to, the embodiments described herein.

Embodiments of the present invention will now be described by way of examples only and with reference to the accompanying drawings, in which:

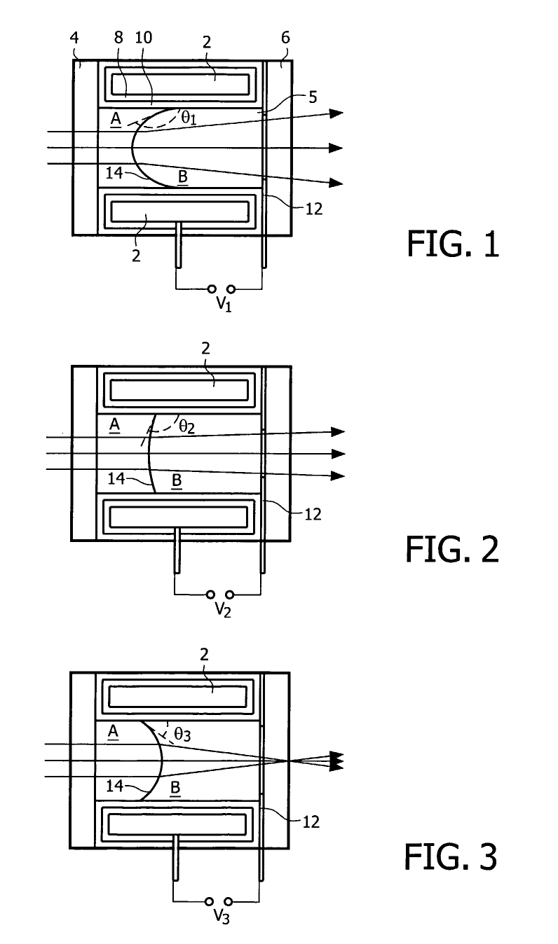

FIGS. 1 to 3 are schematic cross-sectional views illustrating the principle of operation of an exemplary type of variable focus, or “electrowetting”, lens;

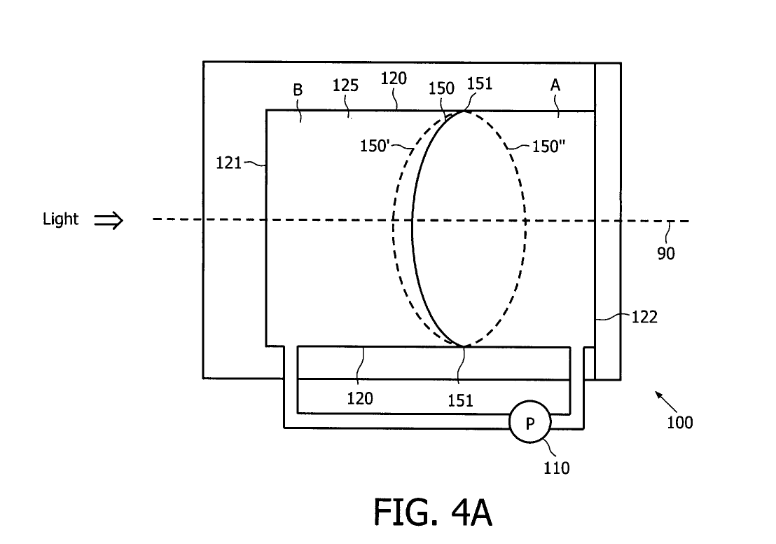

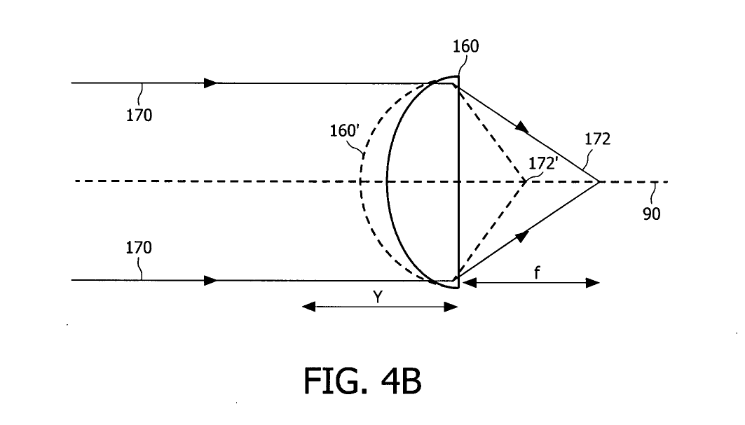

FIGS. 4A and 4B are schematic cross-sectional views illustrating the principle of operation of another exemplary type of variable lens, and the equivilent optical function provided by such a variable lens;

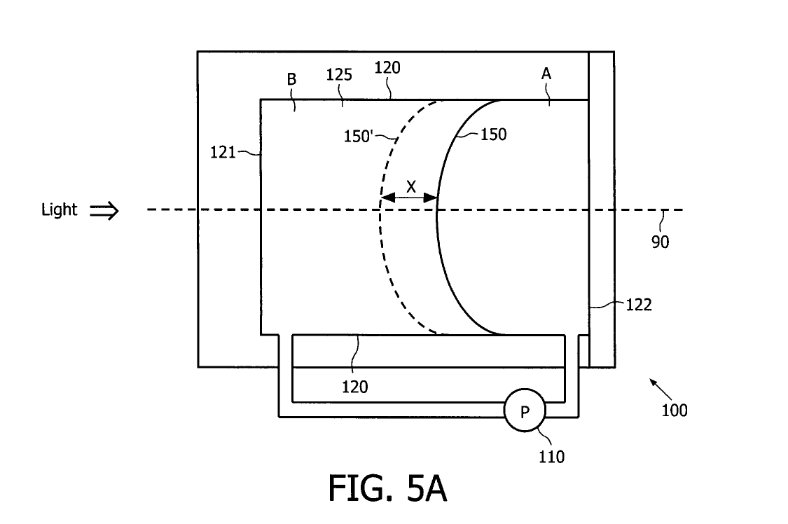

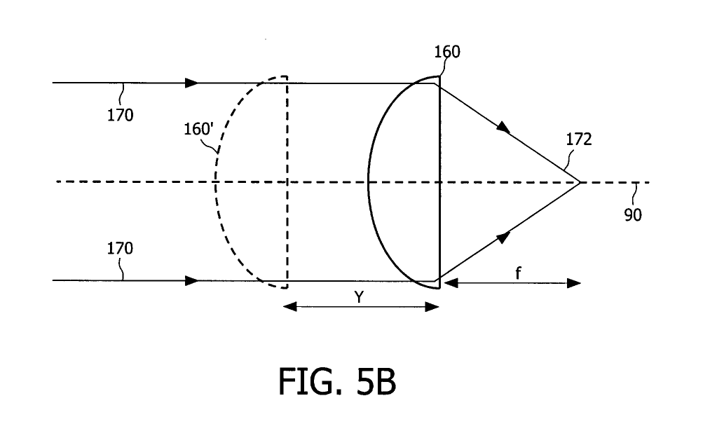

FIG. 5A is a schematic cross-sectional view illustrating the principle of operation of yet another exemplary type of variable focus lens;

FIG. 5B is a schematic illustration of the equivalent optical function of the variable focus lens of FIG. 5A;

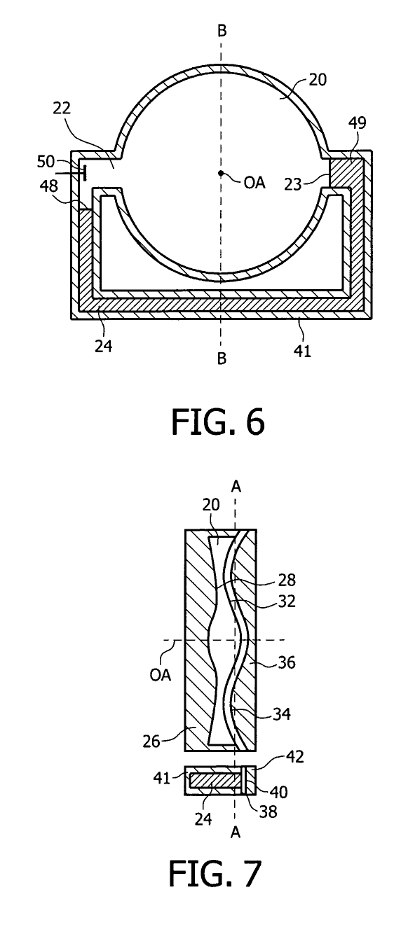

FIGS. 6 and 7 show a schematic cross-section another exemplary type of variable focus lens in a first fluid configuration;

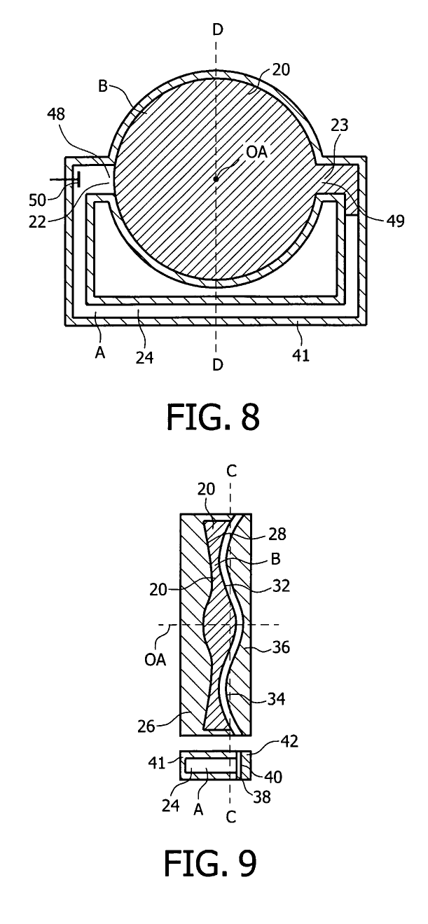

FIGS. 8 and 9 show schematic cross-sections the variable focus lens of FIGS. 6 and 7 in a second fluid configuration;

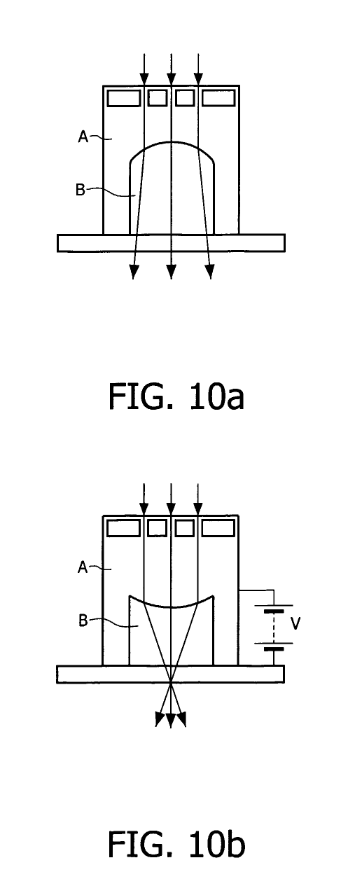

FIGS. 10a and 10b are schematic cross-sectional illustrations of a variable focus lens having two different respective lens positions and, therefore, fluid layer thicknesses;

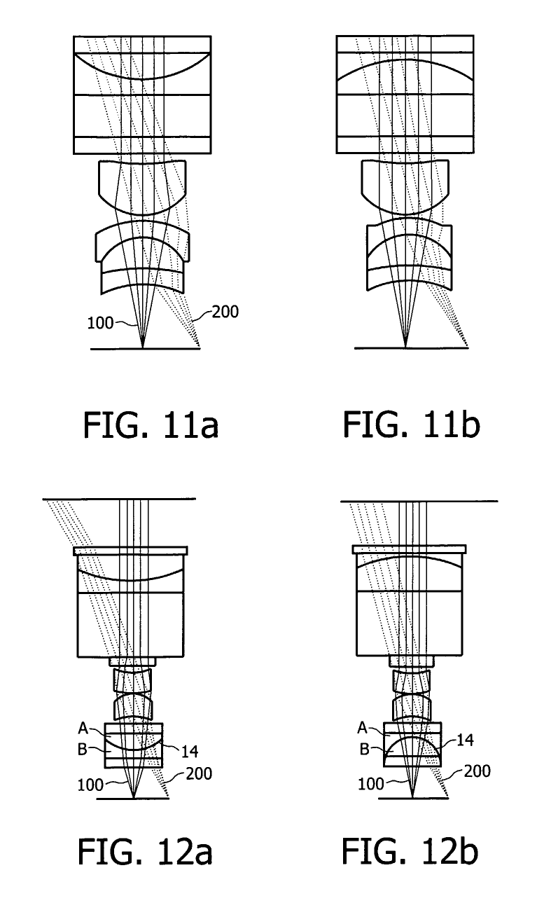

FIG. 11 is a schematic cross-sectional view of an electrowetting lens according to a first exemplary embodiment of the present invention;

FIG. 12 is a schematic cross-sectional view of an electrowetting lens according to a second exemplary embodiment of the present invention; and

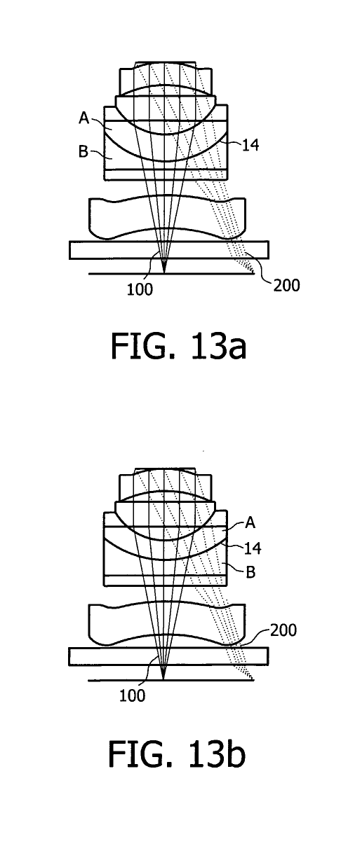

FIG. 13 is a schematic cross-sectional view of an electrowetting lens according to a third exemplary embodiment of the present invention.

Firstly, the principle of operation of a variable focus (or “electrowetting”) lens as described in International Patent Application No. WO 03/069380 will be explained. FIGS. 1 to 3 show a variable focus lens comprising a cylindrical first electrode 2 forming a capillary tube, sealed by means of a transparent front element 4 and a transparent back element 6 to form a fluid chamber 5 containing two fluids. The electrode 2 may be a conducting coating applied on the inner wall of a tube.

In this exemplary design, the two fluids consist of two non-miscible liquids in the form of an electrically insulating first liquid A, such as a silicone oil or an alkane, referred to herein further as “the oil”, and an electrically conducting second liquid B, such as water containing a salt solution. The two liquids may be arranged to have an equal density so that the lens functions independently of orientation, i.e. without dependence on gravitational effects between the two liquids. This may be achieved by, for example, appropriate selection of the first liquid constituent; for example, alkanes or silicon oils may be modified by addition of molecular constituents to increase their density to match that of the salt solution. In this example, the fluids are selected such that the first fluid A has a higher refractive index than the second fluid B.

The first electrode 2 is a cylinder of inner radius typically between 1 mm and 20 mm. The electrode 2 is formed from a metallic material and is coated by an insulating layer 8, formed for example of parylene. The insulating layer is coated with a fluid contact layer 10, which reduces the hysteresis in the contact layer of the meniscus with the cylindrical wall of the fluid chamber. The wettability of the fluid contact layer by the second fluid is substantially equal on both sides of the intersection of the meniscus 14 with the fluid contact layer 10 when no voltage is applied between the first and second electrodes.

A second, annular electrode 12 is arranged at one end of the fluid chamber, in this case, adjacent the back element. The second electrode 12 is arranged with at least one part in the fluid chamber such that the electrode acts on the second fluid B. The two fluids A and B are non-miscible so as to tend to separate into two fluid bodies separated by a meniscus 14. When no voltage is applied between the first and second electrodes, the fluid contact layer has a higher wettability with respect to the first fluid A than the second fluid B. Due to electrowetting, the wettability of the second fluid B varies under the application of a voltage between the first electrode and the second electrode, which tends to change the contact angle of the meniscus at the three phase line (the line of contact between the fluid contact layer 10 and the two liquids A and B). The shape of the meniscus is thus variable in dependence on the applied voltage.

It should be noted at this stage that the meniscus between the first fluid and the second fluid is called concave if the meniscus is hollow as seen from the second fluid. If the first fluid is regarded as a lens, this lens would normally be called concave according to the definition in the previous sentence.

Referring to FIG. 1 of the drawings, when a low voltage V₁, e.g. between 0 V and 20 V, is applied between the electrodes, the meniscus adopts a first concave meniscus shape. In this configuration, the initial contact angle θ₁ between the meniscus and the fluid contact layer 10, measured in the fluid B, is for example, approximately 140°. Due to the higher refractive index of the first fluid A than the second fluid B, the lens formed by the meniscus, here called the meniscus lens, has a relatively high negative power in this configuration.

To reduce the concavity of the meniscus shape, a higher magnitude of voltage is applied between the first and second electrodes. Referring now to FIG. 2, when an intermediate voltage V₂, e.g. between 20 V and 150 V, depending on the thickness of the insulating layer, is applied between the electrodes, the meniscus adopts a second concave meniscus shape having a radius of curvature increased in comparison with the meniscus in FIG. 1. In this configuration, the intermediate contact angle θ₂ between the first fluid A and the fluid contact layer 10 is, for example, approximately 100°. Due to the higher refractive index of the first fluid A than the second fluid B, the meniscus lens in this configuration has a relatively low negative power.

To produce a convex meniscus shape, a yet higher magnitude of voltage is applied between the first and second electrodes. Referring now to FIG. 3 of the drawings, when a relatively high voltage V₃, e.g. 150 V to 200 V, is applied between the electrodes, the meniscus adopts a meniscus shape in which the meniscus is convex. In this configuration, the maximum contact angle θ₃ between the first fluid A and the fluid contact layer 10 is, for example, approximately 60°. Due to the higher refractive index of the first fluid A than the second fluid B, the meniscus lens in this configuration has a positive power.

FIG. 4A shows a variable lens of the type described in unpublished European Patent Application no 03101328.7. The lens 100 can be regarded as being formed from two distinct elements: a lens function formed by the meniscus 150 between two fluids A, B, and a pump 110 arranged to alter the shape of the lens function.

As stated above, a fluid is a substance that alters its shape in response to any force, that tends to flow or to conform to the outline of its chamber, and that includes gases, liquids, vapours, and mixtures of solids and liquids capable of flow.

The two fluids A, B, are substantially immiscible i.e. the two fluids do not mix. The two fluids A, B have different refractive indices. A lens function is thus provided by the meniscus 150 formed along the contact area of the two fluids, as the fluids have different refractive indices. A lens function is the ability of the meniscus 150 to focus (converge or diverge) one or more wavelengths of the light. In this particular embodiment, it is assumed that fluid A has a higher refractive index than fluid B.

The two fluids are preferably of substantially equal density, so as to minimise the effects of gravity upon the lens 100.

The fluids A and B are enclosed within a chamber 125. In this embodiment the chamber 125 takes the form of a longitudinally extending tube, the tube having side walls defined by internal surfaces 120. An optical axis extends longitudinally through the tube. In this particular example, the tube is a cylindrical tube, of constant circular cross-sectional area, and the optical axis is co-axial with the tube axis. Additional walls 121, 122 extend across the ends of the tubes so as to form a chamber 125 enclosing the fluids. At least the portions of the walls 121, 122 of the chamber 125 lying along the optical axis 90 are transparent. If desired, one or both of these walls 121, 122 may be lens shaped.

The meniscus 150 between the two fluids A, B extends transverse the optical axis 90 of the lens 100. The term transverse indicates that the meniscus crosses (i.e. it extends across) the optical axis, and it is not parallel to the optical axis; the meniscus 150 is defined by the side walls 120 of the tube.

Typically, in order to locate the fluids A, B within the desired portion of the chamber 125, different areas of the chamber will have different wettabilities for each fluid, such that each fluid will be attracted by a respective area. Wettability is the extent by which an area is wetted (covered) by a fluid. For instance, if the fluid A is water, and the fluid B is an oil, then the internal surface of the wall 122 may be hydrophilic so as to attract the fluid A and not attract the fluid B.

The perimeter of the meniscus 150 contacts the surfaces 120 of the side walls of the tube. The perimeter of the meniscus is fixedly located on the surface 120. In other words, the position 151 at which the perimeter of the meniscus 150 touches the surface 120 is fixed i.e. the meniscus perimeter is pinned to the surface. In this particular embodiment, the meniscus perimeter is fixed to the surface by an abrupt change in wettability of the surface at position 151 e.g., at position 151 the surface 120 changes from being hydrophobic to hydrophilic.

The shape of the meniscus 150 is determined by both the pressure difference between the two fluids and by the internal diameter of the cylinder. The meniscus 150 illustrated is convex (as viewed from fluid A).

A pump 110 connected to the fluid filled chamber 125 is arranged to pump quantities of one or more of the fluids to and from the chamber 125.

In this particular example, the pump 110 is arranged to simultaneously increase the volume of the fluid A and to decrease the volume of fluid B (and vice versa), so as to maintain the same total volume of the two fluids within the chamber 125. The result will be that the shape of the meniscus 150 will be changed, as the perimeter of the meniscus is pinned to the surface 120.

For instance if extra fluid A is added to chamber 125, then the meniscus shape may change to be more convex i.e. to form the meniscus indicated by the dotted line 150′. Alternatively, if extra fluid B is added, then the meniscus may change shape to that indicated by the dotted line 150″ i.e. the meniscus becomes concave (as viewed from fluid A). It will be appreciated that by altering the volumes of the fluids within the chamber 125, then the meniscus shape can be changed from being convex, to planar, to concave.

It is expected that the maximum curvature of the meniscus shape would be when the meniscus forms a half-sphere. However, it will be appreciated that there is likely to be a threshold pressure at which the meniscus moves, when the pressure becomes so great that the pinning action of the meniscus is overcome, with the result that the meniscus will subsequently move position. Such a threshold pressure is dependent on the magnitude of the change in wettability.

FIG. 4B illustrates the effective optical function, when the refractive index of fluid A is higher than fluid B, provided the meniscus 150 i.e. it is that of a piano convex lens 160, of focal length f. In other words, the meniscus 150 effectively provides the function of a lens 160, which would bring parallel light 170 (incident upon the lens in a direction parallel to the optical axis 90), to a focus 172 a distance f from the lens.

When the meniscus has changed shape (i.e. to the shape shown by the dotted line 150′ in FIG. 4A), then the effective lens function also changes, to that shown by dotted line 160′. As the meniscus 150′ is more curved than meniscus 150, then the lens will be of a higher power i.e. it will have a shorter focal length, bringing parallel light 170 in focus 172′ at a shorter distance from the lens.

In an embodiment shown in FIG. 4A, the meniscus 150 is fixedly located by a change in the wettability of the surface. However, it will be appreciated that other techniques may be used to fix the position of the meniscus perimeter.

As illustrated in FIG. 5 of the drawings, another exemplary type of variable focus lens, as described in unpublished European Patent Application No. 03101335.2, is similar in many respects to that of FIGS. 4A and 4B, and like elements thereof are denoted by the same reference numbers.

Thus in the variable lens illustrated in FIG. 5A the lens 100 can be regarded as being formed of two distinct elements: a lens function formed by meniscus 150 between two fluids A, B, and a pump 110 arranged to alter the position of the lens function.

Once again, a fluid is a substance that alters its shape in response to any force, that tends to flow or conform to the outline of its chamber, and that includes gases, vapours, liquids and mixtures of solids and liquids capable of flow.

As before, two fluids A, B are substantially immiscible i.e. the two fluids do not mix. The two fluids A, B have different refractive indices. A lens function is thus provided by the meniscus 150 formed along the contact area of the two fluids, as the fluids have different refractive indices. A lens function is the ability of the meniscus 150 to focus (converge or diverge) one or more wavelengths of the light.

The two fluids are preferably of substantially equal density, so as to minimise the effects of gravity upon the lens 100.

The fluids A, B are enclosed within a chamber 125. In this embodiment, the chamber 125 takes the form of a longitudinally extending tube defined by the internal surfaces or side walls 120. An optical axis extends longitudinally through the tube. In this particular example, the chamber is a cylindrical tube, of constant circular cross-sectional area, and the optical axis is co-axial with the tube axis. Additional walls 121, 122 extend across the ends of the tube so as to form a chamber 125 enclosing the fluids. At least the portions of the walls 121, 122 of the chamber 125 lying along the optical axis 90 are transparent.

The meniscus 150 between two fluids A, B extends transverse the optical axis 90 of the lens 100. The term transverse indicates that the meniscus crosses (i.e. it extends across) the optical axis, and it is not parallel to the optical axis; the meniscus 150 may cross the optical axis 90 at any desired angle. The perimeter of the meniscus 150 is defined by the side walls 120 of the chamber.

Typically, in order to locate the fluids A, B within the desired portion of the chamber 125, different areas of the chamber will have different wettabilities for each fluid, such as each fluid will be attracted by a respective area. Wettability is the extent by which an area is wetted (covered) by a fluid. For instance, if the fluid 130 is a polar fluid, and the fluid 140 a non-polar fluid, then the internal surface of the wall 122 may be hydrophilic so as to attract the polar fluid A, and not attract the non-polar fluid B.

The shape of the meniscus 150 is determined by the contact angle of the meniscus edge with the internal surfaces 120. Hence the meniscus shape is dependent upon the wettability of the surfaces 120. The meniscus 150 illustrated is convex (as viewed from fluid 130), but the meniscus may be any desired shape e.g. convex, concave or substantially planar.

A pump 110 connected to a fluid filled chamber 125 is arranged to pump quantities of one or more of the fluids to and from the chamber 125. In this particular example, the pump 110 is arranged to simultaneously increase the volume of the fluid A and to decrease the volume of the fluid 140 (and vice versa), so as to maintain the same total volume of the two fluids within the chamber 125. The result will be that the meniscus 150 will be moved along the optical axis 90 as respective fluids are added e.g. if extra fluid A is added, then the meniscus may move a distance X along the optical axis, to the position indicated by the dotted line 150′. In this particular embodiment, the shape of the meniscus is not altered by this movement (as the surfaces 120 are of uniform wettability), only the location of the meniscus along the optical axis 90.

FIG. 5B illustrates the effective optical function provided by the meniscus 150 i.e. it is that of a piano convex lens 160, of focal length f. In other words, the meniscus 150 effectively provides the function of a lens 160, which would bring parallel light 170 (incident upon the lens in a direction parallel to the optical axis 90), to a focus 172 a distance f from the lens.

When the meniscus has moved (i.e. to the position shown by the dotted line 150′ in FIG. 5A), then the effective position of the lens also moves, to that shown by dotted line 160′. As the menisci 150, 150′ are the same shape, then equally they have the same equivalent lens shapes 160, 160′ (and consequently will have the same lens properties i.e. the same power and focal distance).

FIG. 5A indicates that the mensicus is displaced a distance X to the left when it is moved from position 150 to position 150′. Similarly, the equivalent lens function 160′ will also be to the left of the lens function 160. If the ray diagram of FIG. 5B is an illustration of the equivalent functions in vacuo, then 160′ will be to the left of 160 by a distance Y, where Y=X/nA, nA being the refractive index of the fluid A.

Referring to FIGS. 6, and 7 of the drawings, a variable focus lens as described in unpublished Patent Application No 04100025.8 a chamber 20, fluidly connected via two openings 22, 23 of the chamber to a conduit 24 having two opposite ends is shown. The first opening 22 of the chamber is fluidly connected to the first end of the conduit and the second opening 23 of the chamber is fluidly connected to the second end of the conduit so as to form a fluid-tight enclosure for a fluid system. One side of the chamber 20 is enclosed by a wavefront modifier 26 with part 28 having a face exposed to the interior of the chamber 20. The wavefront modifier is formed from a transparent material, for example Zeonex™ which is a cyclo-olefin copolymer (COC) which is non-soluble in aqueous liquids. This may for example be formed by an injection moulding process. The face of part 28 of the wavefront modifier 26 is substantially aspherical and rotationally symmetric about an optical axis OA.

The chamber 20 is further enclosed by a cover plate which comprises a further wavefront modifier 36, which is formed from a transparent is material, similarly for example Zeonex™ and has a different part 32. The different part 32 is covered in a hydrophobic fluid contact layer which is transparent and for example made from Teflon™ AF1600 produced by DuPont™. One surface of this hydrophobic fluid contact layer is exposed to the interior of the chamber 20.

The different part 32 has a face which is aspherical and rotationally symmetric about the optical axis OA. The face of the different part 32 has a differently aspherical curvature to an aspherical curvature of the face of part 28.

A given radiation beam travelling along the optical axis OA is arranged to pass through the part 28 and the different part 32. The wavefront modifier 26 is adapted to perform a first wavefront modification and the further wavefront modifier 36 is adapted to perform a second, different modification on the given radiation beam. The second wavefront modification is arranged to complement the first wavefront modification.

A common, first fluid electrode 50 formed for example from a metal, is located in the conduit 24 near to one opening 22 of the chamber.

A second fluid electrode 34 lies between the cover plate 36 and the hydrophobic fluid contact layer. This second fluid electrode 34 is formed as a sheet of a transparent electrically conducting material, for example indium tin oxide (ITO). An insulating layer (not shown), formed for example of parylene, may be formed between the fluid contact layer and the second fluid electrode 34. It is to be noted that the second electrode 34 has an operative area which completely overlaps with the area occupied by the face of part 28 of the wavefront modifier 26. The hydrophobic fluid contact layer has a surface area which completely overlaps the face of part 28 of the wave front modifier.

The enclosed fluid system comprises a first fluid A and a second fluid B. The first fluid A comprises a polar and/or an electrically conductive fluid. In this example the first fluid A is a liquid and is salted water, having a predetermined first refractive index of approximately 1.37. The salted water has a lower freezing point than non-salted water. The second fluid in this example is preferably gaseous and comprises of air which has a second, different, refractive index of approximately 1. The first fluid A and the second fluid B lie in contact with each other at two fluid menisci 48, 49.

In the first fluid configuration of the switchable optical element, as illustrated by FIGS. 6 and 7, the first fluid A substantially fills the chamber 20 and a portion of the conduit 24. By substantially filling, it is meant that the first fluid A covers at least most of the part 28 of the wavefront modifier 26 and at least most of the different part 32 of the further wavefront modifier 36. In this first fluid configuration, the first fluid lies in contact with at least most of the exposed surface of the hydrophobic fluid contact layer in the chamber. The first fluid electrode 50 lies in contact with the portion of the conduit filled by first fluid A.

The conduit 24 is formed between conduit walls 41 and conduit cover plate 42. The conduit cover plate is covered by a hydrophobic fluid contact layer 38 exposed on one surface to the interior of the conduit 24, the hydrophobic fluid contact layer being formed for example of AF1600™. A third fluid electrode 40 lies between the conduit cover plate 42 and the hydrophobic fluid contact layer 38. This electrode is formed from an electrically conductive material, for example tin oxide (ITO). It is to be noted that the third fluid electrode 40 has a surface area which overlaps with most of the interior of the conduit 24.

The first fluid configuration of the element, the second fluid B substantially fills the conduit 24 except for the portion filled by the first fluid A which is in contact with the common, first fluid electrode 50.

In the second configuration of the switchable optical element, as illustrated by FIGS. 8 and 9, the first fluid A substantially fills the conduit 24. In this second fluid configuration the first fluid A continues to lie in contact with the common first fluid electrowetting electrode 50 located in the previously described portion of the conduit. The first fluid A now lies in contact with the hydrophobic fluid contact layer 38 of the conduit. The second fluid B now substantially fills the chamber 20 such that a second fluid 46 covers at least most of the part 28 of the wavefront modifier 26 and at least most of the different part 32 of the wavefront modifier 36. Additionally a portion of the conduit 24 is filled by the second fluid B. This portion of the conduit 24 is at the opposite end to the portion in which the common, first fluid electrode 50 is located. In the second fluid configuration the first fluid electrode 50 lies in contact with the first fluid A which fills the portion of conduit 24.

A fluid switching system (not shown) is connected to the common first fluid electrode, the second fluid electrode and the third fluid electrode. The fluid switching system acts upon the switchable optical element and is arranged to switch the first and second fluid configurations. In the first fluid configuration the fluid switching system is arranged to apply a voltage V₁ of an appropriate value across the common, first fluid electrode 50 and the second fluid electrode 34. The applied voltage V₁ provides switchable electrowetting forces such that the switchable optical element of the present invention tends to adopt the first fluid configuration wherein the electrically conductive first fluid 44 moves to substantially fill the chamber 20. As a result of the applied voltage V₁, the hydrophobic fluid contact layer of the chamber 20 temporarily becomes at least relatively hydrophilic in nature, thus aiding the preference of the first fluid A to substantially fill the chamber 20. It is envisaged that whilst in the first fluid configuration, no voltage is applied across the common, first electrode 50 and the third electrowetting electrode 40, such that the fluid contact layer in the conduit remains highly hydrophobic.

In order to switch between the first fluid configuration and the second fluid configuration of the switchable optical element, the fluid switching system switches off the applied voltage V₁ and applies a second applied voltage V₂ of an appropriate value across the common, first fluid electrode 50 and the third fluid electrode 40. No voltage is applied across the common, first fluid electrode 50 and the second fluid electrode 34.

The switchable optical element now lies in the second fluid configuration state, in which the first fluid A substantially fills the conduit 24 as a result of switchable electrowetting forces provided by the applied voltage V₂. With the applied voltage V₂ the hydrophobic fluid contact layer 38 of the conduit 24 is now at least relatively hydrophilic and tends to attract the first fluid A. The first fluid A moves to fill the portion of the conduit 24 in which the common first fluid electrode 50 is located. As earlier described, the second fluid 46 now substantially fills the chamber 20. The hydrophobic fluid contact layer of the chamber 20 is now relatively highly hydrophobic and aids this arranging of the second fluid in the second fluid configuration.

During the transition between the first and second fluid configurations of the element, as controlled by the fluid switching system, the first and second fluids A, B of the fluid system flow in a circulatory manner through the fluid system, each of the fluids displacing each other. In this circulatory fluid flow during the transition from the first to the second fluid configuration, the first fluid A passes out of the chamber 20 into one end of the conduit 24 via one opening 22 of the chamber. Simultaneously the second fluid 46 passes from the other end of the conduit 24 into the chamber 20 via the other opening 23 of the chamber. During the transition, from the second to the first fluid configuration, an opposite circulatory fluid flow occurs.

Thus, when changing from the first fluid configuration to the second fluid configuration, the applied voltage V₂ across the third fluid electrode 40 and the common, first fluid electrode 50 attracts the electrically conductive first fluid A into the chamber 20, thus displacing the electrically insulating second fluid B out of the chamber 20. Additionally, the hydrophobic fluid contact layer 32 of the chamber 20 repels the electrically conductive first fluid A out of chamber 20 into conduit 24. The transition from the second to the first fluid configuration is the reverse of the transition from the first to the second transition state in these terms.

Once again, as stated above, the refractive indices of the two respective fluids A and B are different, and it is highly advantageous if the difference between these refractive indices is relatively high, in order to obtain a good zoom factor, bearing in mind that the non-conductive fluid (e.g. oil) tends to have a higher refractive index than the conductive fluid (i.e. the electrolyte), although this is not essential. Many oils with a high refractive index (approximately above 1.7) are not colourless, but instead tend to be yellow (for example, in the case of selenium disulfide, the refractive index n=1.85, and its colour is yellow). However, this causes colour changes in the image of an object compared with the object itself, such that a limitation has been placed on the oils having a high refractive index which can be used in a variable focus lens of the electrowetting type.

The present invention proposes to solve the above-mentioned problem by correcting or compensating for the resultant change of colour of an image of an object, compared with the object itself, caused by the use of a non-colourless fluid as the first and/or second fluid, the fluids having different indices of refraction, wherein the lens function of the variable focus lens can be selectively controlled.

This colour correction/compensation can be achieved in a number of different ways, according to the present invention, some of which will now be described in more detail.

For example, in the case where an electronic image sensor is used (as opposed to conventional photographic film), the so-called white balance can be adjusted electronically in the image sensor. As a specific example of this, if a yellow oil is used in the variable focus lens, which absorbs part of the blue light, then the signal created in the yellow and green pixels can be decreased electronically. However, as illustrated comparatively between the schematic illustrations of FIGS. 10a and 10b, the thickness of the oil layer A varies with varying lens position (for varying object distances or zoom positions), thereby varying the degree of colour changing effect the yellow oil has on the resultant image. This problem can be solved by measuring the actual lens position or fluid layer thickness (for example, by measuring capacitance or voltage) and then correcting the output signal of the sensor according to the measured thickness of the oil layer.

In another possible method of correcting or compensating for colour changes caused by the use of non-colourless fluids in a variable focus lens, a dye or similar substance may be added to the non-colourless fluid to counteract the adverse effect on the image of its colour. Thus, once again, if an oil is used which is yellow, and this yellow oil absorbs part of the blue light, then dyes can be dissolved in the oil which absorb part of the green and yellow light. Suitable dyes will be apparent to a person skilled in the art. In this way, the need for electronic correction is eliminated and the above-mentioned varying oil layer thickness does not influence the colour spectrum.

In yet another exemplary method of colour correction or compensation according to the invention, an appropriate colour filter can be used to counteract the relevant colour-changing effect of the non-colourless fluid. Thus, once again, if a yellow oil is used which absorbs part of the blue light, then a colour filter may be located in the lightpath that absorbs part of the green and yellow light accordingly. It will be appreciated in this case, however, that there will still be a need to correct electronically as the changing meniscus varies the thickness of the fluid layer.

Another option would be to dissolve in the other fluid, i.e. the electrolyte in the arrangement described above, a dye having the same level and type of colour absorption as the non-colourless fluid (e.g. oil). As a result, it is possible to correct for, say, the partly absorbed blue light using electronic means, a solid filter, or by dissolving other dyes in both of the fluids. Correction or compensation for the varying thickness of the fluid layer is not necessary, although a disadvantage is that more light is lost using this solution than when a dye is simply added to the non-colourless fluid in question, as described above.

In another embodiment, the lens may be designed such that the stop of the device is close to the position of the meniscus. Absorption of portions of the light by the non-colourless fluid is now independent of the field configuration and only a colour correction for the entire sensor device is required. If necessary, this correction can be adjusted for the various curvatures of the meniscus.

In yet another embodiment, the wall of the container can be shaped such that the thickness of the non-colourless oil layer is substantially the same for the various field configurations in the default configuration. In the case that only a moderate shape change of the meniscus is required, only a colour correction for the entire sensor is required.

Referring now to FIGS. 11 to 13 of the drawings, respective exemplary embodiments of electrowetting lenses, of the type described with reference to FIGS. 1 to 3 will now be described, in the context of the present invention with the reference numbers used in FIGS. 11 to 13 denoting like elements with respect to the arrangement of FIGS. 1 to 3.

Thus, in FIG. 11 of the drawings, a variable focus lens based on the electrowetting principle is illustrated schematically. As illustrated, when the concavity of the meniscus 14 is reduced by switching from the configuration illustrated in FIG. 11a to that illustrated in FIG. 11b, there is only a very small variation in the thickness of the fluid layer A. Furthermore, the principle beam 100 and the marginal beam 200 do not alter much as a result of switching such that a fixed level of colour correction for the complete sensor is sufficient and no correction per pixel is required. The simplest form of colour correction proposed above, whereby the so-called white balance can be adjusted electronically in the image sensor, can be used.

FIG. 12 illustrates a zoom lens based on the electrowetting principle, whereby the change in thickness of the layer of fluid A is significantly more substantial between the zoom condition of FIG. 12a and that of FIG. 12b. Furthermore, the layer thicknesses are different for the principal beam 100 than for the marginal beam 200. This means that the simplest form of colour correction at the sensor level is inadequate and a correction per pixel and per zoom configuration is required to be provided. In this case, the method whereby a dye is added to the non-colourless fluid A and/or the second fluid B, as described above, may be used.

FIG. 13 illustrates a zoom lens with a binary electrowetting lens, in which the absorption of light by the non-colourless fluid depends, at least for the binary lens, only moderately on the switching because the cavity of the binary lens remains the same. On average, the marginal beam 200 passes through the same amount of liquid when averaged over the entire beam. Thus, if only fluid A of the binary lens is non-colourless, then the simplest form of colour correction proposed above, whereby the so-called white balance can be adjusted electronically in the image sensor, can be used.

The manner in which various configurations of variable focus lenses are designed, and the factors to be taken into consideration therein, are numerous and will be apparent to a person skilled in the art.

It should be noted that the above-mentioned embodiment illustrates rather than limits the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A variable focus lens comprising a first fluid (A) and a second fluid (B), said fluids (A,B) having different indices of refraction, wherein the lens function of said variable focus lens can be selectively controlled, at least one of said fluids (A,B) being non-colourless, the lens further comprising means for correcting for a colour change which would otherwise occur in an image of an object compared with the object itself as a result of said non-colourless fluid.

2. A lens according to claim 1, wherein said colour change correcting means comprises a dye or similar pigmentation material added to the non-colourless fluid (A) to counteract the effect thereof on the colour of the image.

3. A lens according to claim 1, wherein said colour change correcting means comprises colour filter means placed in the lightpath (100) to counteract the effect of said non-colourless fluid (A) on the colour of the image.

4. A lens according to claim 1, wherein said colour change correcting means comprises a dye or similar pigmentation material added to the fluid (B) other than the non-colourless fluid (A).

5. A lens according to claim 4, wherein the dye or other pigmentation material has substantially the same level and type of colour absorption as the non-colourless fluid (A).

6. A lens according to claim 1, wherein the inner wall of said fluid chamber (5) is shaped such that the thickness of the non-colourless fluid layer is substantially the same, irrespective of the shape of the meniscus (14).

7. A lens according to claim 1, wherein the non-colourless fluid is a liquid having an index of refraction greater than 1.5.

8. A lens according to claim 7, wherein the index of refraction of said non-colourless fluid is greater than 1.7.

9. A lens according to claim 7, wherein the non-colourless fluid comprises an oil having a refractive index greater than 1.5.

10. A lens according to claim 11, wherein the non-colourless fluid has a refractive index greater than 1.7.

11. A lens according to claim 1, wherein said non-colourless fluid is yellow, red or brown.

12. A lens according to claim 1, wherein the second fluid (B) is axially displaced from the first fluid (A), the fluids (A,B) being in contact over a meniscus (14), the lens further comprising a first electrode (2) and a second electrode (12), wherein the shape of the meniscus (14) can be controlled in dependence on the application of a voltage between the first electrode (2) and the said second electrode (12).

13. A lens according to claim 12, comprising a substantially cylindrical fluid chamber (5), and a fluid contact layer (10) arranged on the insiee of the cylinder wall.

14. A lens according to claim 13, wherein the first electrode (2) is separated from the first fluid (A) and the second fluid (B) by the fluid contact layer (10), and the second electrode (12) is arranged and configured to act on the second fluid (B).

15. A lens according to claim 13, wherein the fluid contact layer (10) is arranged to have a wettability by the second fluid (B) which varies under the application of a voltage between the first electrode (2) and the second electrode (12), such that the shape of the meniscus (14) varies in dependence on the said voltage.

16. A lens according to claim 13, wherein the wettability of the fluid contact layer (10) by the second fluid (B) is substantially equal on both sides of the intersection of the meniscus (14) with the fluid contact layer (10) when no voltage is applied between the first and second electrodes (2,12).

17. A lens according to claim 13, wherein the first fluid (A) includes an insulating fluid and the second fluid (B) includes a conducting liquid.

18. A lens according to claim 1, comprising a chamber (125) defined by at least one side wall having an optical axis (90) extending longitudinally through the chamber (125), wherein the chamber (125) contains the fluids (A,B), which are in contact over a meniscus (150), the lens further comprising at least one pump (110) for altering the relative volume of each of the fluids (A,B) contained within the chamber (125).

19. A lens according to claim 18, wherein the perimeter of the meniscus (150) is constrained by the side wall, and the at least one pump (110) is arranged to controllably alter the position of the meniscus (150) along the optical axis by altering the relative volume of each of the fluids (A,B) contained within the chamber (125).

20. A lens according to claim 18, wherein the perimeter of the meniscus (150) is fixedly located on an internal surface of the chamber (125) and the at least one pump (110) is arranged to controllably alter the shape of the meniscus (150) by altering the relative volume of each of the fluids (A,B) contained within the chamber (125).

21. A lens according to claim 18, wherein the wettability of the internal surface of the chamber (125) varies longitudinally, and is arranged to be controllably altered by the electrowetting effect.

22. A lens according to claim 1, arranged to provide a variable zoom setting for a beam of readiation, and comprising a switchable optical element having a first mode and a second mode, the element including the first fluid (A), the second fluid (B) and a wavefront modifier (26) having a part (28) through which the radiation is arranged to pass, where in the first mode, the switchable optical element has a first fluid configuration in which the part (28) is substantially covered by the first fluid (A) and in a second mode, the switchable optical element has a second different, fluid configuration in which the part (28) is substantially covered by the second fluid (B).

23. A lens according to claim 22, wherein the switchable optical element (34) comprises a common first fluid electrode (50), a second different fluid electrode (34) and a third, different, fluid electrode (40), wherein in the first fluid configuration, the element is arranged to provide switchable electrowetting forces by applying a first voltage across the first (5) and second (34) fluid electrodes, and in the second fluid configuration, the element is arranged to provide different switchable electrowetting forces by applying a second, different voltage across the first (50) and third (40) fluid electrodes.

24. An optical system including a variable focus lens comprising a first fluid (A) and a second fluid (B), the fluids (A,B) having different indices of refraction, wherein the lens function of the variable focus lens can be selectively controlled, at least one of said fluids being non-colourless so as to absorb at least a portion of a light beam passing therethrough and causing a colour change in an image of an object compared with the object itself, the optical system further comprising means for correcting for said colour change.

25. An optical system according to claim 24, comprising an electronic image sensor, wherein means are provided for electronically adjusting the white balance of the image so as to counteract the effect on the colour thereof by the non-colourless fluid (A).

26. An optical system according to claim 24, arranged and configured such that the stop thereof is relatively close to the position of the meniscus (14) between the first fluid and the second fluid.

27. An optical system of wherein said colour change correcting means comprises a dye or similar pigmentation material added to the non-colourless fluid (A) to counteract the effect thereof on the colour of the image.

28. An image capture device including a variable focus lens according to claim 1.

29. An optical scanning device for scanning an optical record carrier, the optical scanning device including a variable focus lens according to claim 1.
